(19) United States
(12) Patent Application Publication
(10) Pub. No.: US 2008/0235470 A1
(43) Pub. Date: Sep. 25, 2008

(54) ACCESSING INFORMATION FROM A REMOVABLE STORAGE UNIT

(76) Inventor: Darren J. Cepulis, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/688,369

(22) Filed: Mar. 20, 2007

(51) Int. Cl. G06F 12/16

(52) U.S. Cl. 711/162

(57) ABSTRACT

A system comprising a processor and a removable solid-state storage unit adapted to be accessed by the processor and comprising information. Upon detecting the presence of the storage unit, the processor copies the information to a system storage coupled to the processor. The processor accesses the information from the system storage in response to a request to access a different storage apparatus.

### BACKGROUND

Computers (e.g., servers) may load data from and store data to various types of storage media. Such storage media may include floppy disks, universal system bus (USB) storage devices, ZIP® disks, compact discs, etc. However, not all computers are equipped to access all types of storage media. For example, a server may have a USB drive, enabling it to access a USB storage device, but may lack a floppy drive, precluding it from accessing a floppy disk.

Some computers have operating systems that require installation of additional software (e.g., drivers) to help the computer function properly. However, the operating systems may be programmed to obtain such software from only a specific type of media (e.g., from only a floppy disk). Computers unable to read that specific type of media may encounter difficulty in obtaining and installing the required software. For example, a computer that requires software to be obtained from a floppy disk, but which lacks a floppy drive, will encounter difficulty in obtaining and installing the software.

### BRIEF DESCRIPTION OF THE DRAWINGS

For a detailed description of exemplary embodiments, reference will now be made to the accompanying drawings in which:

FIG. 1 shows a solid-state storage device in accordance with various embodiments;

FIG. 2 shows a memory map of memory housed within the device of FIG. 1, in accordance with various embodiments;

FIG. 3 illustrates a computer system which may be used with the device of FIG. 1, in accordance with various embodiments;

FIG. 4 shows a block diagram of the computer system of FIG. 3, in accordance with various embodiments; and

FIG. 5 shows a flow diagram of a method implemented in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Described herein is a technique by which a solid-state, non-volatile memory (NVM) device (e.g., a universal system bus (USB) flash drive) removably coupled to a computer system is formatted as another type of storage device. For example, a USB flash drive may be formatted as a floppy disk. Further, a NVM device formatted as another type of storage device is used to load software onto a computer that is unable to read from the another type of storage device and that requires that the software be obtained only through the other type of storage device. Such an electronic device, which requires software to be provided only by a specific type of media, but which is not able to use (or does not have) that type of media, is referred to herein as a “selective electronic device” (SED).

For example, a SED that runs the WINDOWS® 2003 operating system (OS) may require a driver so that it can perform a particular function. The OS may require that the driver be obtained only from a floppy disk. However, the SED may lack a floppy drive. In this case, a floppy disk cannot be used to provide the driver to the OS. As such, a different media—such as a USB storage device—is formatted as a floppy disk and is then used to provide the driver to the OS. In this way, the OS determines (or “thinks”) that it is receiving the driver from a floppy disk, but in reality the OS is receiving the driver from the USB storage device.

Accordingly, there is first described an illustrative technique by which a NVM device may be formatted as a floppy disk. There is subsequently provided a description of an illustrative technique by which the contents of the formatted NVM device are transferred to a SED in accordance with embodiments of the invention. Although the various techniques are described herein in terms of a USB device formatted as a floppy, it should be understood that the same techniques may be applied to any storage device that is formatted as another type of storage device. For example, the techniques described herein may be applied to a USB device formatted as a CD-ROM; a compact flash device may be formatted as a USB device, etc.

A NVM device that has been formatted as a floppy disk is said to contain an “embedded floppy disk,” or EFD. An EFD may be generated on any suitable NVM device that can be removably coupled to a computer, such as a USB flash device or a flash memory stick. In at least some embodiments, the EFD comprises a data structure generated on the NVM device. The EFD generation techniques disclosed herein are described in the context of a USB flash device, but the scope of this disclosure is not limited to applying the EFD generating techniques solely to USB flash devices. Any non-volatile memory device may be used. For example, optical discs (e.g., CD-ROMs, BLU-RAY® discs, HD-DVD discs, holographic discs), MILLIPEDE® storage units, magnetic tape-based storage units, etc. may be used.

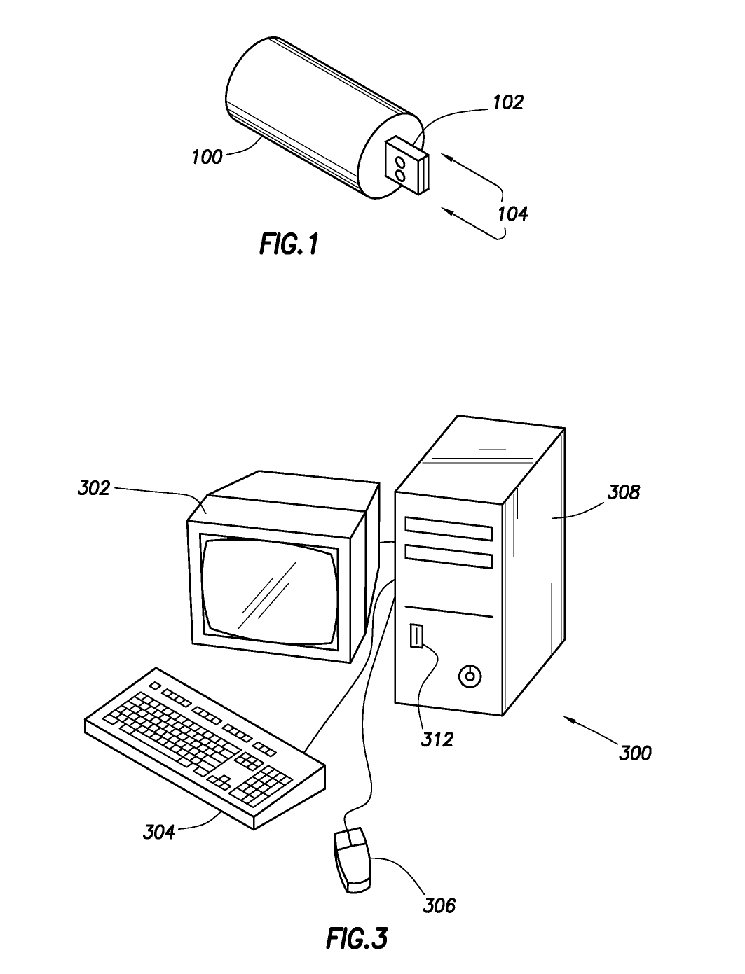

FIG. 1 shows a perspective view of an illustrative device 100. The device 100 may comprise any removable, solid-state storage device, such as a USB flash device. The device 100 comprises an external connector 102 used to couple the device 100 to a computer via, for example, a USB port. The device 100 houses solid-state based memory (not specifically shown) which may be of any suitable type or size (e.g., 256 MB, 1 GB).

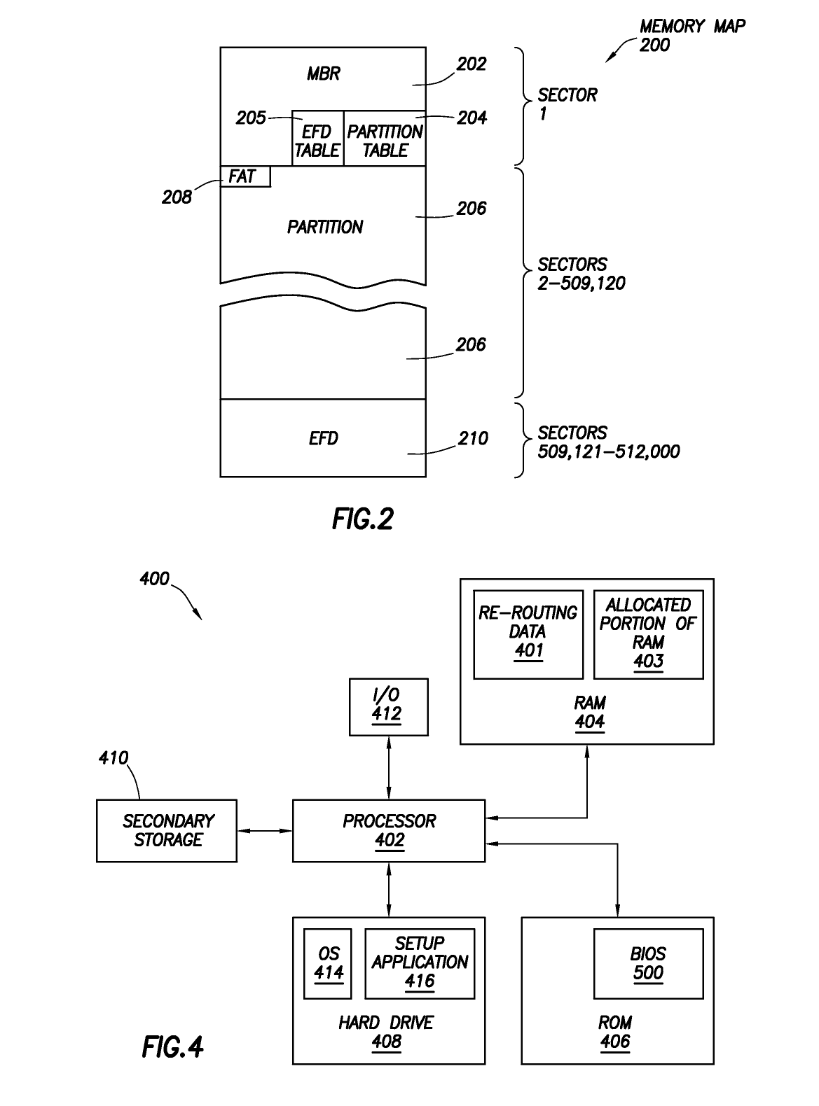

The memory housed within the device 100 comprises a plurality of sectors. In an illustrative embodiment, the device 100 memory comprises 256 MB, with 2000 sectors per MB, for a total of 512,000 sectors. Other configurations are possible as well. FIG. 2 shows the use of 512,000 sectors of a memory map 200 which represents memory within the device 100. The map shown in FIG. 2 is illustrative of various embodiments of the invention and does not limit the scope of disclosure. The map 200 may be stored, for instance, in the RAM 404, the hard drive 408 or any other suitable storage. Sector 1 comprises a master boot record (MBR) 202 which in turn comprises a partition table 204 and an EFD table 205. Sectors 2-509,120 comprise a data partition 206 comprising a file allocation table (FAT) 208. A partition is a section of the memory represented by memory map 200. Each partition is regarded as one logical storage unit, and contains one set of files. Sectors 509,121-512,000 comprise an EFD 210. Thus, in at least some embodiments, the EFD 210 comprises a total of 2,880 sectors. The EFD 210 is allocated 2,880 sectors (i.e., 1.44 MB) because, as described above, the EFD 210 is formatted as a floppy disk, and most floppy disks comprise 2,880 sectors (or 1.44 MB). In other embodiments, the EFD 210 contains more or less than 2,880 sectors. The contents of each sector are now described in turn.

The MBR 202 comprises information that instructs a computer coupled to the device 100 as to how the device 100 should be booted. Specifically, the partition table 204 describes the location (e.g., sector) of the beginning of each partition. In the embodiment of FIG. 2, the memory map 200 is shown as comprising only one partition 206. Thus, the partition table 204 cross-references partition 206 with sector 2, since sector 2 is the first sector in the partition 206. The FAT 208 describes the contents of the partition 206. For example, if the partition 206 comprises a file A starting at sector 5, file B starting at sector 100,000, and file C starting at sector 200,345, then the FAT 208 cross-references files A, B and C with sectors 5, 100,000, and 200,345, respectively. In at least some embodiments, neither the partition table 204 nor the FAT 208 indicates the presence of the EFD 210. The EFD 210 is kept separate from the remainder of memory map 200 in this way because, unlike the partition(s) of the memory map 200, the EFD 210 is formatted as a floppy drive. Being formatted as a floppy drive, the EFD 210 is regarded by a computer coupled thereto as a storage device physically separate from the device 100, although in reality, the EFD 210 is embedded within the device 100. Thus, files stored in the EFD 210 are segregated from the filing system of the remainder of the device 100. An indication in the partition table 204 or the FAT 208 as to the presence of the EFD 210 may undesirably open up the EFD 210 to intermingling with the remainder of the device 100.

Moreover, in an embodiment in which the EFD 210 is the last component of the memory map 200, as shown in FIG. 2, the FAT 208 does not indicate the presence of the sectors occupied by the EFD 210. For example, in the embodiment of FIG. 2, the FAT 208 indicates that the memory map 200 only comprises 509,120 sectors, when in reality the memory map 200 comprises 512,000 sectors. By omitting the sectors occupied by the EFD 200, segregation between the EFD 210 and other partition(s) in the memory map 200 is maintained. In case the EFD 210 is not the last component of the memory map 200 (e.g., the EFD 210 is embedded in the partition 206), the 2,880 sectors corresponding to the EFD 210 are classified as “bad” or unusable sectors in the FAT 208. In this way, as a computer reads the FAT 208 to access data from the partition 206, the sectors comprising the EFD 210 remain unavailable to the computer.

As previously mentioned, the EFD 210 is segregated from the partition 206 in this way because the partition 206 is used as a USB flash device, whereas the EFD 210 is used as a floppy disk. Intermingling between files in the EFD 210 and the remainder of the device 100 would prevent the EFD 210 from imitating a floppy drive that is separate and distinct from the remainder of the device 100. The EFD table 205 comprises a plurality of bits that indicate the presence of the EFD 210 and the position of the EFD 210 in the memory map 200.

In at least some cases, flash drives may not be manufactured with the EFD 210 and the EFD table 205. Instead, the EFD 210 and the EFD table 205 are embedded into a flash drive by an end-user to achieve a configuration such as that shown in FIG. 2. The end-user embeds the EFD 210 and the EFD table 205 in the memory represented by memory map 200 using a software application (a USB flash drive “setup application,” described below) that is executed on a computer system such as that shown in FIG. 3.

FIG. 3 shows a general-purpose computer system 300 (e.g., a personal computer or a server) comprising a display device 302, input devices (e.g., a keyboard 304, a mouse 306), and a computer chassis 308. The chassis 308 comprises a USB port 312. The chassis 308 also comprises circuit logic represented by the block diagram of FIG. 4. System 400 of FIG. 4 shows a processor 402 which couples to a random access memory (RAM) 404, a read-only memory (ROM) 406 comprising basic input/output system (BIOS) firmware 500, and a hard drive 408. The processor 402 is further coupled to a secondary storage device 410 and one or more input/output (I/O) devices 412.

The secondary storage device 410 comprises, e.g., the USB device 100. The one or more input/output (I/O) devices 412 may include, but are not limited to, devices such as video displays, track balls, mice, keyboards, microphones, touch-sensitive displays, transducer card readers, magnetic or paper tape readers, tablets, styluses, voice or handwriting recognizers, other computers or other well-known input devices.

The USB device 100 is coupled to the computer system 300 by inserting connector 102 into the USB port 312. In this way, the USB device 100 becomes accessible to the processor 402, as the secondary storage device 410 is shown to be accessible to the processor 402 in FIG. 4. The processor 402 executes software applications stored on the RAM 404, the ROM 406 and/or the hard drive 408. In some cases, a software application stored on the ROM 406 may be copied to the RAM 404 and then executed from RAM by the processor 402. One software application that may be executed by the processor 402 is an operating system (OS) 414, stored on the hard drive 408. In at least some embodiments, the OS 414 belongs to the WINDOWS® or LINUX® families, although the scope of disclosure is not limited as such. The hard drive 408 also stores a USB device setup application 416.

When executed by the processor 402, the setup application 416 enables an end-user of the computer system 300 to configure the memory associated with the memory map 200 as desired. Any of a variety of configuration options may be provided to the end-user. One such configuration option is the ability to allocate a specific portion of the memory as the EFD 210. For example, in some embodiments, the setup application 416 causes the processor 402 to determine the number of sectors in the memory map 200. The processor 402 then provides this information to the end-user (e.g., by way of a graphical user interface (GUI) on the display 302). In the embodiment shown in FIG. 2, the memory map 200 comprises 512,000 sectors. The end-user is provided with the option of designating one or more of the 512,000 sectors as an EFD. For example, the end-user may designate sectors 509,121-512,000 as the EFD, resulting in the configuration shown in FIG. 2. Alternatively, the end-user may designate sectors 397,121-400,000 or some other group of sectors as the EFD. The scope of disclosure is not limited to selecting any particular number of sectors, nor is the scope of disclosure limited to selecting sectors in any particular portion of the memory map 200. In case the end-user designates as the EFD a portion of the memory map 200 that already contains data, the end-user is provided with the option to select a different portion of the memory map 200 for the EFD, to move the data present in the selected portion of the memory map 200, or to overwrite the data present in the selected portion of the memory map 200. In at least some embodiments, the EFD 210 comprises approximately 1.44 MB, since most floppy disks comprise 1.44 MB and because the EFD 210 is formatted as a floppy disk.

Once the end-user has allocated a portion of the memory map 200 as the EFD 210, the setup application 416 automatically generates and populates an EFD table. In the embodiment of FIG. 2, the EFD table 205 comprises a plurality of bits that indicate the presence of the EFD 210 and that the EFD 210 is located at the user-designated location (e.g., sectors 509,121-512,000).

In at least some embodiments, the introduction of an EFD into an already-configured flash drive memory may necessitate re-configuration of the partition table and/or the FATs of the various partitions present in the memory. For example, assume the partition 206 of the memory map 200 comprised sectors 2-512,000 prior to generation of the EFD 210. The generation of the EFD 210 in sectors 509,191-512,000 causes the size of the partition 206 to change. The setup application 416 may cause the processor 402 to update the partition table 204 to reflect such changes in the partition 206. The processor 402 also may update the FAT 208 to reflect such changes in the partition 206.

To summarize the foregoing, the setup application 416 causes the processor 402 to allocate a portion of the memory map 200 for the EFD 210, and to generate and populate an EFD table 205. The setup application 416 also causes the processor 402 to update the partition table 204 and/or the FAT 208, and any other pertinent tables in the memory map 200, to reflect changes in the configuration of the memory map 200. The scope of disclosure is not limited to generating a single EFD 210 per device 100. Instead, multiple EFDs may be generated as desired, and EFD tables corresponding to the EFDs may be generated and populated as described above. As previously explained, the techniques described herein may apply to a USB device formatted as a floppy as well as to any suitable storage device formatted as another type of storage device. The computer system 300 interacts with (e.g., reads data from) the EFD 210 as is now described.

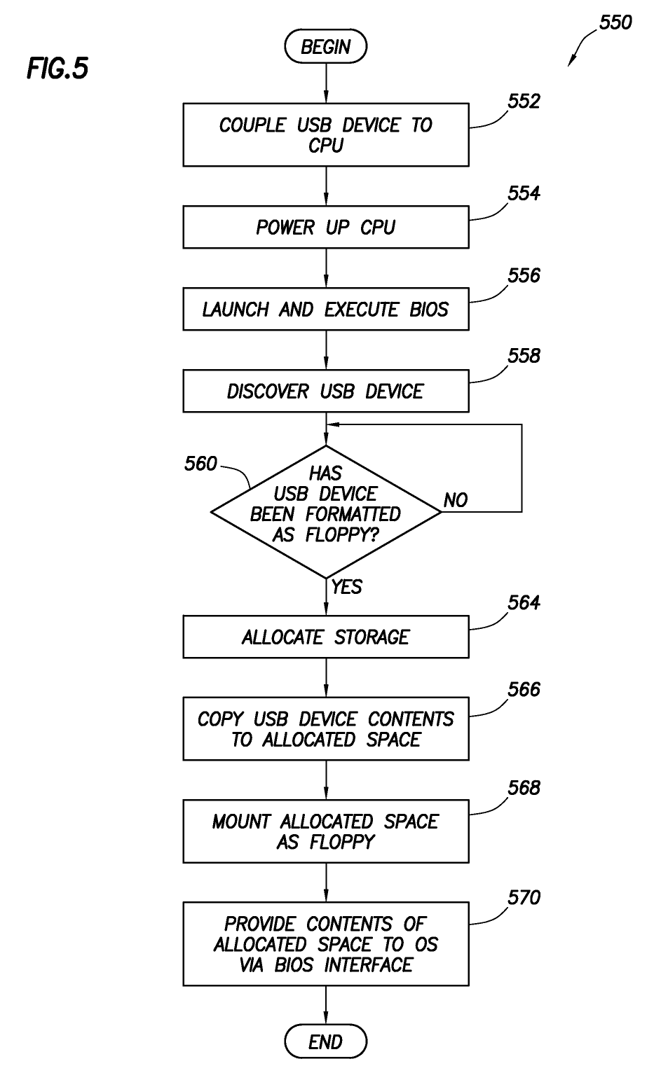

As explained above, the OS 414 may require software to be obtained from a floppy disk, but the system 300 may lack a floppy disk drive. Accordingly, referring to FIG. 5, there is now described a method 550 by which the USB device 100 comprising the EFD 210 (i.e., formatted as a floppy drive) is coupled to the chassis 308. The order of the various actions can be altered from that shown in FIG. 5. The method 550 includes detection of the EFD 210 by logic inside the chassis 308, transfer of data on the EFD 210 to destination memory in the chassis 308, and mounting of the destination memory in the chassis 308 as a floppy drive. Thus, the processor 402 accesses what it determines is a floppy drive, but is actually memory in the chassis 308. In this way, software that is stored on the USB device 100 and that is required by a SED is provided to the SED without using a floppy disk or drive.

The method 550 begins with coupling the USB device 100 to the chassis 308 by coupling the connector 102 to the USB port 312 (block 552). It is assumed that the EFD 210 and the EFD table 205 already have been generated on the USB device 100. The EFD 210 and the EFD table 205 are generated, for example, by an end-user using the setup application 416 as described above. Alternatively, the EFD 210 and table 205 may have been generated by the manufacturer of the USB device 100. The method 550 then comprises powering up the computer (block 554). When the computer is powered up, the processor 402 launches and executes the BIOS 500 (block 556). The BIOS 500 comprises firmware which is used to boot up the computer and to configure I/O devices coupled to the chassis 308. When executed, the BIOS 500 causes the processor 402 to locate I/O devices (e.g., the keyboard 304, mouse 306, display 302, USB device 100) and to boot the devices. The BIOS 500 also causes the processor 402 to boot the OS 414.

While in real mode, the BIOS 500 causes the processor 402 to search the system 300 for bootable I/O devices, such as those mentioned above. In searching for bootable devices, the processor 402 discovers the USB device 100 plugged in the USB port 312 (block 558). The processor 402 then determines whether the USB device 100 has been formatted as, e.g., a floppy disk (block 560).

After the processor 402 has discovered the presence of a USB device formatted as a floppy disk coupled to the chassis 308 (block 560), the BIOS 500 causes the processor 402 to allocate a portion 403 of the RAM 404 (block 564) or of some other storage housed within the chassis 308. Preferably, the processor 402 allocates 1.44 MB of the RAM 404, because most floppy disks contain 1.44 MB of storage space. The processor 402 then copies some or all of the contents of the EFD 210 to the allocated storage space 403 within RAM via the connector 102 and the USB port 312 (block 566). In some embodiments, the processor 402 copies all contents of the EFD 210 (e.g., 1.44 MB) to the storage space 403. In this way, any software needed by the OS 414 that was previously stored on the EFD 210 of the USB device 100 is transferred to the storage space 403 allocated in the RAM 404 for use by the EFD 210.

At this point in the method 550, the software needed by the OS 414 is stored in RAM 404. However, as previously explained, the OS 414 in a SED may require that the software be provided to the OS 414 by way of a specific type of media (e.g., a floppy disk and associated floppy drive). Thus, in accordance with embodiments of the invention, the method 550 further comprises mounting the storage space 403 allocated in the RAM 404 as a floppy drive, thereby causing the OS 414 to detect the allocated space 403 as a floppy drive (block 568). In this way, if the OS 414 detects that the space 403 allocated in RAM 404 is a floppy drive, the OS 414 will accept the software it needs from the RAM 404 (block 570), all the while “thinking” that it is actually accepting the software from a floppy disk. That is, the OS 414 obtains the software in the same manner regardless of whether the software is on a floppy disk or on the allocated portion of the RAM 404—the use of the allocated RAM is transparent to the OS 414. The technique by which the 1.44 MB of space allocated in RAM 404 is mounted as a floppy drive is now described.

As previously explained, allocated space 403 in the RAM 404 comprises the data (or “floppy image”) obtained from the USB 100. This allocated portion of RAM 404 is mounted as a floppy drive by the BIOS 500. Stated otherwise, the BIOS 500 interfaces with other software in the system 400 (including the OS 414) to re-route accesses intended for a floppy drive to the allocated portion 403 of RAM 404 instead. For example, the BIOS 500 may receive an INT13 call from software to access a floppy drive (e.g., drive B:\). Because the chassis 308 lacks a floppy drive, the BIOS 500 re-routes the INT13 call to the allocated portion 403 of RAM 404 which comprises the floppy image. In this way, the BIOS 500 enables software stored on the system 400 to access a floppy image stored on the RAM 404 which would otherwise not have been accessible.

The BIOS 500 may re-route received access requests (e.g., INT13 calls) using any suitable method. For example, the RAM 404 may contain re-routing data 401 (e.g., a table, data structure, flags, bits and/or any other suitable mechanism(s)) which is usable to indicate how the BIOS 500 should re-route calls to specific destinations. In an illustrative instance, upon receiving a data request from the OS 414 to a floppy drive B:\, the BIOS 500 may check the re-routing data 401 to determine how the BIOS 500 should re-route the request. The re-routing data 401 may indicate that requests to floppy drive B:\ should be re-routed to the allocated portion of RAM 404 containing the floppy image described above. Accordingly, the BIOS 500 may send the request from the OS 414 to the allocated portion 403 of RAM instead of sending the request to the floppy drive B:\ (since the floppy drive B:\ does not exist). In turn, the BIOS 500 may receive the requested data from the floppy image in the allocated portion 403 of RAM and may forward the data to the OS 414. Although a floppy drive B:\ was not accessed, the OS 414 “thinks” that a floppy drive B:\ was accessed. In this way, accesses between the OS 414 and the floppy image on RAM 404 are transparent to the OS 414.

The above discussion is meant to be illustrative of the principles and various embodiments of the present invention. As previously explained, although the above embodiments are described primarily in terms of floppy drives and disks, USB storage devices, non-volatile memory, RAM, etc., the scope of this disclosure is not limited as such. The scope of this disclosure includes application of the techniques described above to any suitable computer system configuration. For instance, using the techniques described above, a USB storage device formatted as a CD-ROM may have a portion of its contents copied to an allocated portion of RAM. The allocated RAM may then be mounted as a CD-ROM drive. In this way, software that is required to be provided to a SED via a CD-ROM may be provided to the SED even when the SED lacks a CD-ROM drive. Various embodiments may use different types of media for different purposes, and numerous variations and modifications will become apparent to those skilled in the art once the above disclosure is fully appreciated. The following claims should be interpreted to embrace all such variations and modifications.

What is claimed is:

1. A system, comprising:
a processor; and
a removable solid-state storage unit adapted to be accessed by the processor and comprising information;
wherein, upon detecting the presence of the storage unit, the processor copies said information to a system storage coupled to the processor;
wherein the processor accesses the information from the system storage in response to a request to access a different storage apparatus.

2. The system of claim 1, wherein the removable solid-state storage unit comprises a universal serial bus (USB) device.

3. The system of claim 1, wherein the removable solid-state storage unit comprises a data structure which causes the processor to determine that the removable solid-state storage unit is formatted as said different storage apparatus.

4. The system of claim 1, wherein said different storage apparatus comprises a floppy disk.

5. The system of claim 1, wherein the processor copies said information from the removable solid-state storage unit to space allocated in the system storage.

6. The system of claim 1, wherein the system storage comprises random access memory (RAM).

7. The system of claim 1, wherein said different storage apparatus is associated with a 1.44 MB floppy disk.

8. The system of claim 1, wherein the processor accesses the information from the system storage in response to a request to access a different storage apparatus at least in part by executing basic input/output system (BIOS) software which re-routes said request to the system storage.

9. A method, comprising:
detecting the presence of a first storage unit, said first storage unit formatted as a second storage unit;
reproducing contents of the first storage unit on a third storage unit;
adjusting a data structure to associate the second and third storage units with each other; and
accessing the third storage unit in response to a request to access the second storage unit.

10. The method of claim 9, wherein said first storage unit comprises a universal serial bus (USB) flash device and the second storage unit comprises a floppy disk.

11. The method of claim 9, wherein the second storage unit is associated with a 1.44 MB floppy disk.

12. The method of claim 9, wherein the third storage unit comprises random access memory (RAM).

13. The method of claim 9, wherein accessing the third storage unit in response to a request to access the second storage unit comprises a basic input/output system (BIOS) interface re-routing said request to the third storage unit.

14. A system, comprising:
means for detecting the presence of a first storage unit, said first storage unit formatted as a second storage unit;
means for copying contents of the first storage unit to a third storage unit; and
means for accessing said contents on the third storage unit in response to a request to access said contents on the second storage unit.

15. The system of claim 14, wherein said means for accessing comprises a data structure which associates the second and third storage units with each other.

16. The system of claim 14, wherein the first storage unit comprises a universal serial bus (USB) storage device.

17. The system of claim 14, wherein the second storage unit is associated with a 1.44 MB floppy disk.

18. The system of claim 14, wherein the third storage unit comprises random access memory (RAM) that is associated with the second storage unit.

19. The system of claim 14, wherein the means for accessing said contents on the third storage unit in response to a request to access said contents on the second storage unit comprises basic input/output system (BIOS) software which re-routes said request to the third storage.
